(19) United States
(12) Patent Application Publication
(10) Pub. No.: US 2013/0068751 A1
(43) Pub. Date: Mar. 21, 2013

(54) COOKING APPLIANCE WITH DETACHABLE POWER AND THERMOSTAT UNIT

(71) Applicant: Feng Jinzhao, Foshan (CN)

(72) Inventor: Feng Jinzhao, Foshan (CN)

(21) Appl. No.: 13/280,486

(22) Filed: Oct. 25, 2011

(30) Foreign Application Priority Data
Nov. 1, 2010 (CN) 201010531436.5

(51) Int. Cl. H05B 3/68

(52) U.S. Cl. 219/448.11

(57) ABSTRACT

The invention involves a detachable powerplug connector and plug seat connection of an electric griddle. A thermostat is in a plug control box, to which external power input connector is connected. A temperature control knob is fixed on the plug control box, and a socket with plug through-hole is installed at the front end of the plug control box. A heat transfer inserting hole is in the thermostat and received a heat transfer rod extending from the pan body between the plugs in a flexible way, and the end will get in touch with the thermostat, which enables the pan body to transfer heat directly to the thermostat in the plug control box via the heat transfer rod. The plug control box is equipped with an independent adjustable temperature control knob connected to the thermostat, which will facilitate temperature adjustment for the users.

### CROSS REFERENCE TO RELATED APPLICATIONS

This application claims priority to Chinese Patent Application number 201010531436.5 filed Nov. 1, 2010

### FIELD OF THE INVENTION

The invention involves technology in the field of electric cooking appliances such as griddles, frying pans, and pancake makers. In particular, the invention relates to those appliances having a detachable power plug connector and plug seat connection structure immediately adjacent the cooking surface, for example, on a handle thereof.

### BACKGROUND OF THE INVENTION

With the continuous improvement of living standards, electric cooking appliances for frying, burning and baking foods etc. have begun to be widely used by families, especially the electric frying pan or pancake maker, whose structure includes an electric frying pan body or an electric frying plate with a cooking surface. A power cord stretches out from the electric frying pan body or electric frying plate. The outer end of the power cord is designed as a plug connected to the external power supply, and the other end is connected to the heating element in a fixed mode. When used, the outer plug of the power cord can be directly connected to external power supply. However, there are still inadequacies as follows in the structure of the electric frying pan: (1) the body of the power line is connected to the appliance (heating elements) in a fixed mode, which can not be split. If the power cord is damaged, it will be difficult to replace. The pan can even be out of use because the power cord is damaged; (2) because the power line cannot be split from the electric frying pan body or electric frying plate, it will be inconvenient to put them away when we do not use them; (3) because the power line cannot be split from the electric frying pan body or electric frying plate, it will be impossible to wash them in dish-washing machine.

Other electric cookers on the market also use ordinary plugs and sockets to connect the pan body and the power cord. Although the cord can be split from the pan body or the plate, there are still inadequacies as follows: (1) there is gap between the heat transfer units on the plugs or sockets, that is, there is no direct metal contact; the indirect heat transfer through air causes ineffectiveness in heat transfer, inaccuracies in the temperature-sensing data on the thermostat and impreciseness in temperature control; (2) the power line is connected to the pan body in a very simple way, using plug and socket; they are not tightly connected and easy to loose, so they may affect the use. (3) This simple plug and socket connection is low in safety factor, which makes it easy for children to pull out the power line directly; (4) it can even work when the plug is not plugged to the top end (that is not fully plugged into the socket); and when the thermostat does not work, it is likely to cause dry heating; there are insecurity risks because the units are not tightly connected and they cause heating.

### SUMMARY OF THE INVENTION

The invention aims to overcome the above inadequacies and invent a kind of detachable power plug connector and plug seat connection structure for cooking appliances, such as frying pans or griddles, which is compact in structure, effective in heat transfer and high in safety. The power cord is tightly connected to the pan body and it is easy to operate.

The invention applies the following technical solution to solve the technical problems:

A detachable power plug connector and plug seat connection structure of a kind of immediate heat-actuated electric frying pan include the pan body and its active plug control box. A thermostat is installed in the plug control box, to which external power input connector is connected. And the external power input connector is connected to the thermostat. It has the characteristics as follows: a temperature control knob is fixed on the described plug control box, and a socket with plug through-hole is installed at the front end of the plug control box. A plug stretching out from the heating unit at the bottom of the described pan body can be connected to the plug through-hole. There is a heat transfer inserting hole on the corresponding thermostat. A heat transfer rod stretching out from the pan body between the plugs can be connected to the heat transfer inserting hole in a flexible way, and the end will get in touch with the thermostat, which enables the pan body to transfer heat directly to the thermostat in the plug control box via the heat transfer rod. As for this electric frying pan, the pan body and plate can be plugged into the plug control box in a detachable mode. The heat transfer rod can be plugged into the heat transfer inserting hole on the socket and directly get in touch with the thermostat. The heat transfer rod extends its end and gets in touch with the temperature-sensing chip of the thermostat at the bottom of the heat transfer inserting hole through a metallic coupler, which is flexible and frictionally engages the exterior of heat transfer rod, enabling the temperature of the pan body and the plate to be directly conducted to the thermostat. The units are closely connected, and very effective in heat transfer, which makes the temperature-sensing data on the thermostat quite accurate, and temperature control highly precise. The plug control box is equipped with an independent adjustable temperature control knob connected to the thermostat, which will facilitate temperature adjustment for the users.

The invention also applies the following technologies:

As a more detailed implement scheme, the coupler is a generally cylindrical metal contact coupler extending axially from the described thermostat. It is flexible and comprised of several prongs or segments that deform, deflect, or expand when the heat transfer rod is inserted into the heat transfer hole. The coupler thus can compress tightly the outside end of the heat transfer rod in advance, before the heat transfer rod is plugged into the heat transfer inserting hole and gets in touch with the thermostat. The metal contact coupler extends axially from temperature-sensing chip in the thermostat, which can prevent dry heating. When the heat transfer rod is plugged into the heat transfer inserting hole but not in touch with the thermostat, the metal contact coupler can compress tightly the outside of the heat transfer rod in advance to test the temperature and improve safety.

A supporting bracket is installed on the peripheral edge of the described pan body; and a limit cavity is formed extending out from the supporting bracket above the plug. An active rocker is installed in the corresponding limit cavity on the top of the upper terminal fixing cover, and it can be adjusted and fixed in the limit cavity when the socket of the plug control box is connected to the plug of the pan body. When plugging the plug control box with the pan body, the active rocker can be used to firmly connect the plug through-hole of the socket in the plug control box to the pan body, preventing loosening and being pulled out by children casually to improve safety. If the electric frying pan is not in use, the active rocker can be adjusted to be separated from the limit cavity, plugging the plug control box off the pan body to make it easy to put them away; it is reasonable in overall structure, convenient and easy in operation.

The described active rocker is coiled into curving pipe fittings with a blocking convex part, one side of the curving pipe fittings can be blocked in the groove of the upper terminal fixing cover by means of rotating, the other side stretches out from the plug control box and has a handle; when rotating the curving pipe fittings, its central blocking convex part will be blocked in the limit cavity of the limit mask. In this way, the plug of the pan body can be locked in the socket of the plug control box.

The convex buckle stretches out from the inner side of the handle of the described active rocker, and at the corresponding position of the convex buckle on the side wall of the shell of the plug control box, there is a buckle position hole which can be used to block the convex buckle. When the blocking convex part of the active rocker is blocked in the limit block of the pan body, the plug can be locked in the socket by fastening the convex buckle of the handle to the buckle position hole on the side wall of the plug control box.

There is a push button hole on the side wall of the shell of the described plug control box, and a push button is installed in the push button hole; the push button is connected to the rocker lever, which is cased by a return spring; an ejector block is installed at the upper end of the rocker lever.

In order to unlock the plug and the socket conveniently, the supporting convex column stretches from both sides of the described rocker lever; a supporting frame is installed at the corresponding position of the supporting convex column in the shell of the plug control box; the rocker lever is installed on the supporting frame via the supporting convex column, the upper and lower end of which are respectively connected to buckle position hole and the push button; a return spring plate is installed on the rocker lever near the supporting convex column, which is connected to the inner side of the shell of the plug control box by a return spring; the rocker lever can push the ejector block out of the buckle position hole by compressing the return spring. When using, you just need to press the push button, the return spring on the rocker lever will be compressed to the inner wall of the plug control box. Then the ejector block at the upper end of the rocker lever will wave around the supporting convex column and extend out from the buckle position hole and push away the convex buckle on the handle, unlocking the convex buckle on the inner side of the handle from the buckle position hole.

The described plug control box is made up of the upper and lower shell joining together.

Two mutually perpendicular engaging vertical and horizontal planetary wheels are installed in the plug control box below the described temperature control knob; the horizontal planetary wheel is connected to the thermostat; connecting shaft is installed on the vertical planetary wheel, it extends out and then is plugged to the upper shell of the plug control box; the temperature control knob is plugged and connected to the connecting shaft.

Protective cover stretches from the lower end of the plug of the described pan body, and can play a guiding and supportive role when plugging in the socket of the plug control box.

The invention has the following beneficial effects:

(1) The invention involves detachable power plug connector and plug seat connection structure of a kind of immediate heat-actuated electric frying pan. The pan body can be plugged into the plug control box in a detachable mode. The heat transfer rod can be plugged into the heat transfer inserting hole on the socket and directly get in touch with the thermostat. The heat transfer rod extends its end and gets in touch with the temperature-sensing chip of the thermostat at the bottom of the heat transfer inserting hole, enabling the temperature of the pan body and the plate to be directly conducted to the thermostat via the heat transfer rod. The units are closely connected, and very effective in heat transfer, which makes the temperature-sensing data on the thermostat quite accurate, and temperature control highly precise. The plug control box is equipped with an independent adjustable temperature control knob connected to the thermostat, which will facilitate temperature adjustment for the users.

(2) The invention involves detachable power plug connector and plug seat connection structure of a kind of immediate heat-actuated electric frying pan. The connecting handle at the outer end of the active rocker can both facilitate adjustment and block the plug and the socket by the convex buckle on the inner side of the handle, in combination with the buckle position on the outer wall of the shell of the plug control box; what's more, to facilitate “unlocking”, there is a push button hole on the side wall of the shell of the described plug control box, and a push button is installed in the push button hole; the push button is connected to the rocker lever, which is cased by a return spring; an ejector block is installed at the upper end of the rocker lever; when it is necessary to pull out the plug control box, you just need to press the push button, and the return spring will be compressed to the inner wall of the plug control box. Then using the lever principle, the ejector block at the upper end of the rocker lever will wave around the supporting convex column and extend to the convex buckle in the buckle position hole and push away the handle, unlocking the convex buckle on the inner side of the handle from the buckle position hole. It is easy and convenient in operation.

(3) The invention involves detachable power plug connector and plug seat connection structure of a kind of immediate heat-actuated electric frying pan. To facilitate independent washing of the pan body, the metal contact chip stretches out in the axis from the temperature-sensing chip in the thermostat, which can prevent dry heating. When the heat transfer rod is plugged into the heat transfer inserting hole but not in touch with the thermostat, the metal contact chip can compress tightly the outside of the heat transfer rod in advance to test the temperature and improve safety.

### BRIEF DESCRIPTION OF THE DRAWINGS

FIG. 1 is the section structure diagram of the invention;

FIG. 2 is the enlarged structure diagram of Point A in FIG. 1 of the invention;

FIG. 3 is the structure diagram of FIG. 1 of the invention from another angle;

FIG. 4 is the decomposition structure diagram of the invention;

FIG. 5 is the decomposition structure diagram of the invention from another angle;

FIG. 6 is the diagram of the invention removing the plug control box;

FIG. 7 is the enlarged view of Point B in FIG. 6 of the invention;

FIG. 8 is the structure diagram of the plug control box of the invention removing some elements;

FIG. 9 is the structure diagram of the plug control box of the invention removing some elements;

FIG. 10 is the structure diagram of the plug control box of the invention;

FIG. 11 is the structure diagram of the plug control box of the invention removing some elements;

FIG. 12 is the structure diagram corresponding to FIG. 11 of the invention from another angle;

### DETAILED DESCRIPTION OF THE INVENTION

Hereby the invention will be further interpreted in combination with the appended figures and implement scheme.

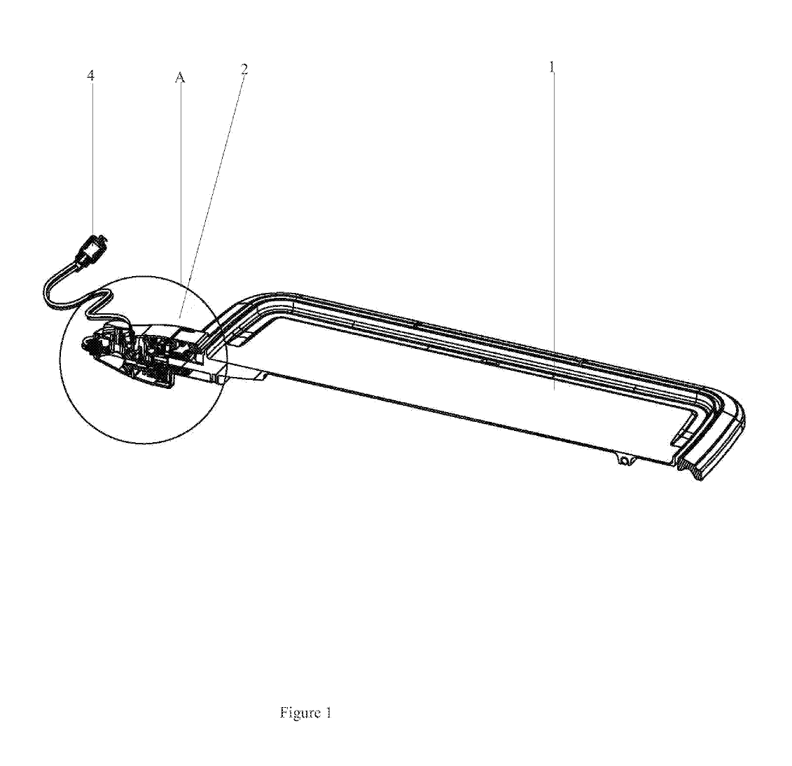

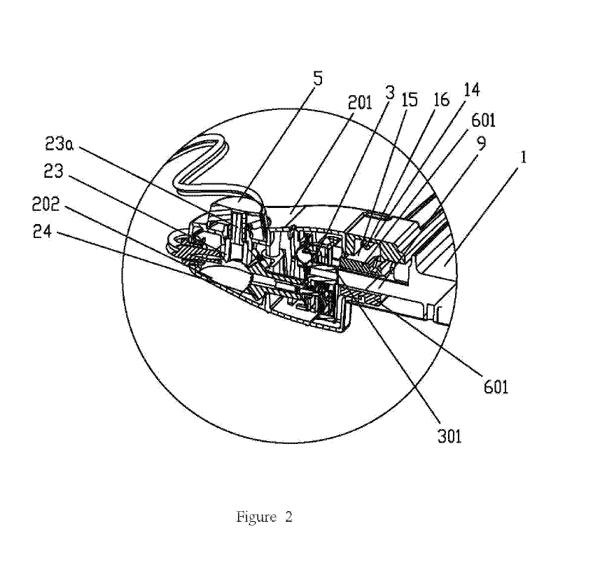

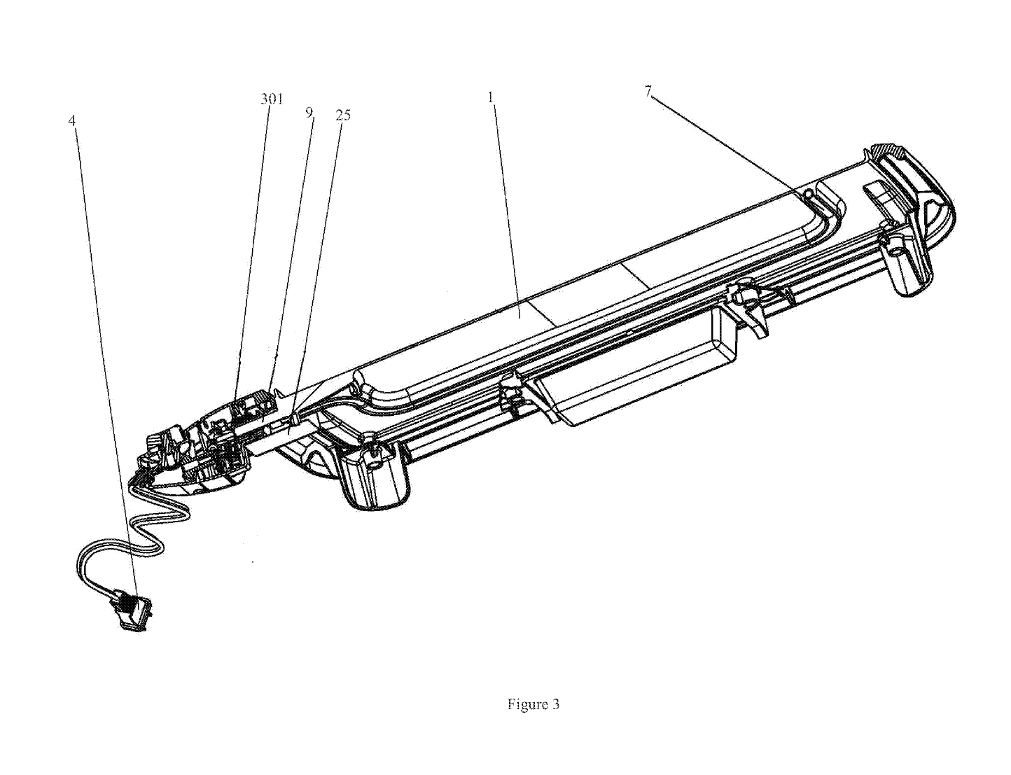

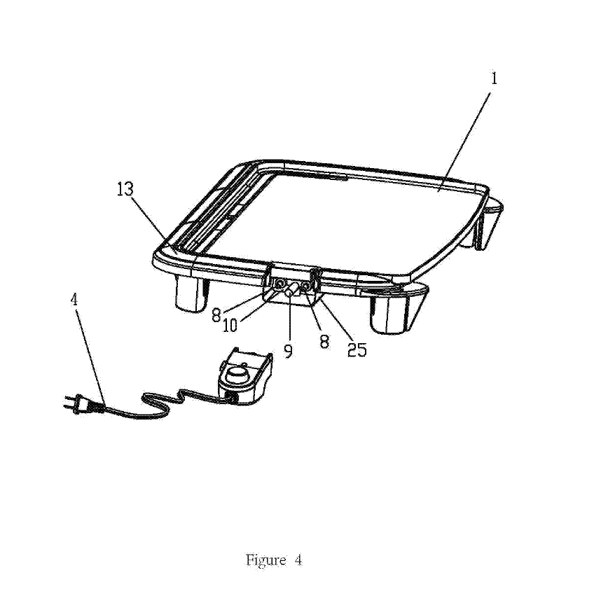

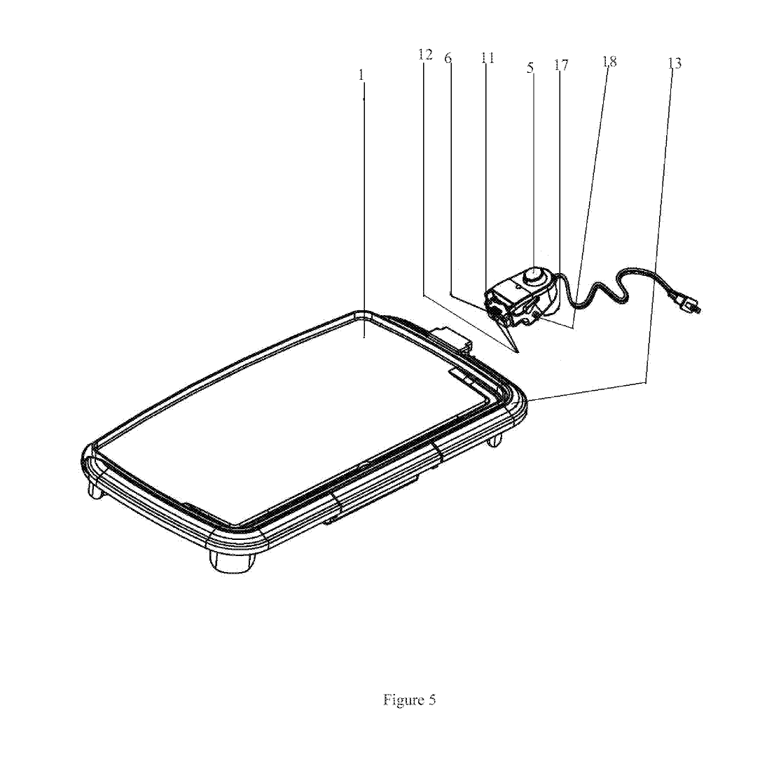

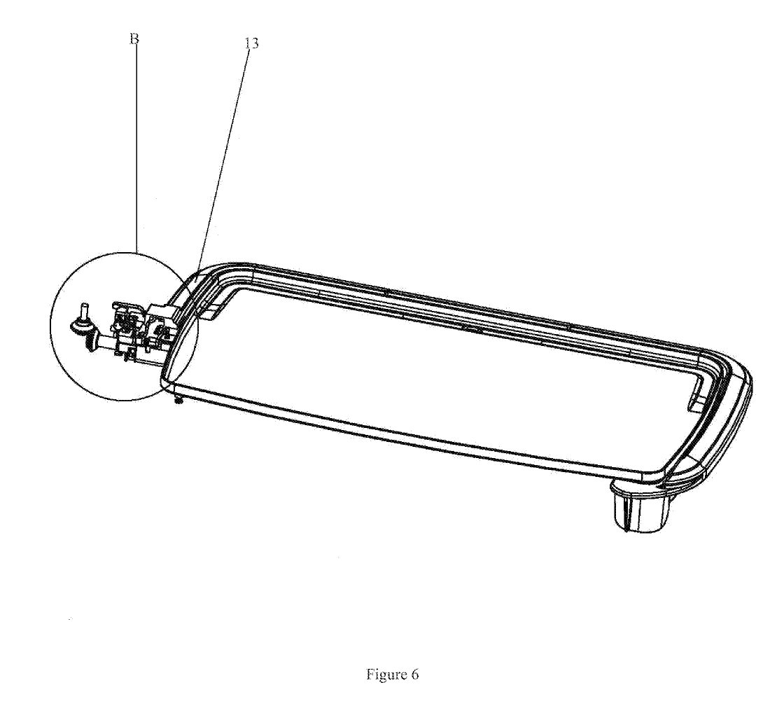

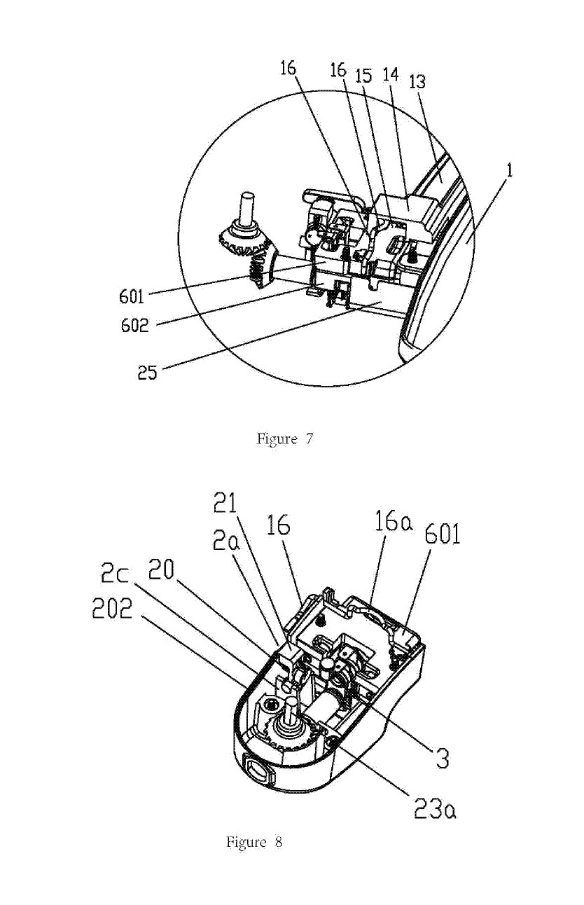

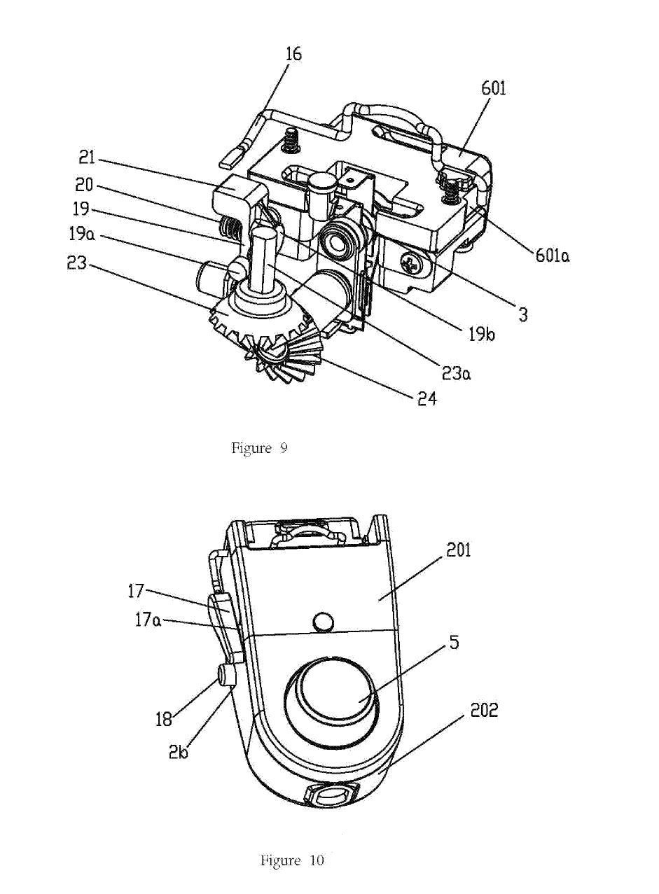

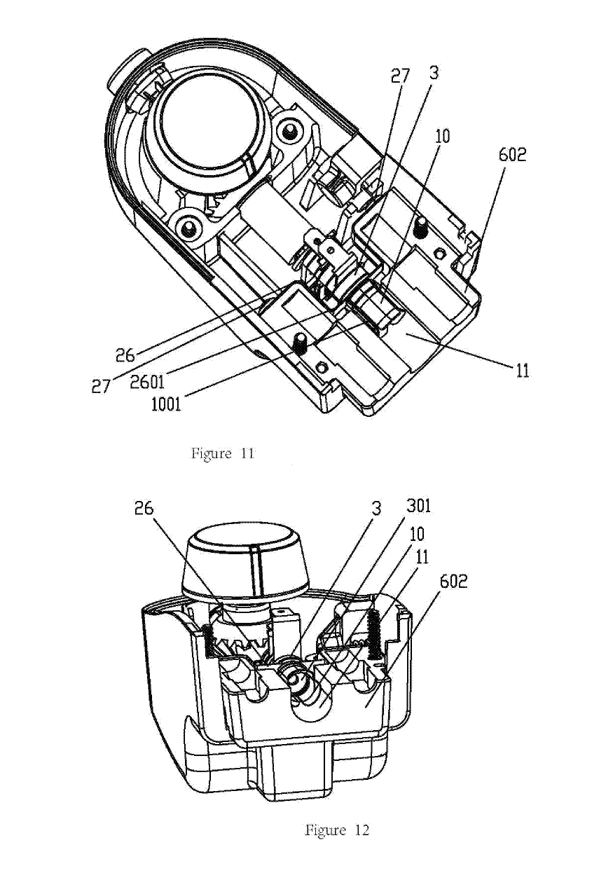

As shown in FIG. 1 to FIG. 12, a detachable power plug connector and plug seat connection structure for a heat-actuated cooking appliance or electric frying pan is illustrated. The assembly includes the pan body 1 with a cooking surface, and an active plug control box 2. A thermostat 3 is installed in the plug control box 2, to which external power input connector 4 is connected. The external power input connector 4 is connected to the thermostat 3. A temperature control knob 5 is fixed on the described plug control box 2, and a socket 6 with plug through-hole 12 is installed at the front end of the plug control box 2. A plug 8 stretching out from the heating unit 7 at the bottom of the described pan body 1 can be connected to the plug through-hole 12. There is a heat transfer inserting hole 11 on the socket 6 of the corresponding thermostat 3. A heat transfer rod 9 stretching out from the pan body 1 between the plugs 8 can be connected to the heat transfer inserting hole 11 in a flexible way, and the end will get in touch with the thermostat 3, which enables the pan body 1 to transfer heat directly to the thermostat 3 in the plug control box 2 via the heat transfer rod 9. As for this electric frying pan, the pan body 1 can be plugged into the plug control box 2 in a detachable mode. The heat transfer rod 9 can be plugged into the heat transfer inserting hole 11 on the socket 6 and directly get in touch with the thermostat 3. The heat transfer rod 9 extends its end and gets in touch with the temperature-sensing chip 301 of the thermostat 3 at the bottom of the heat transfer inserting hole 11, enabling the temperature of the pan body 1 to be directly conducted to the thermostat 3 via the heat transfer rod 9. The units are closely connected, and very effective in heat transfer, which makes the temperature-sensing data on the thermostat 3 quite accurate, and temperature control highly precise. The plug control box 2 is equipped with an independently adjustable temperature control knob 5 connected to the thermostat 3, which will facilitate temperature adjustment for the users.

As a more detailed implement scheme, the metallic coupler 10 extending axially from the described thermostat 3 into the heat transfer inserting hole 11 can compress tightly the outside end of the heat transfer rod 9 in advance, before the heat transfer rod 9 is fully plugged into the heat transfer inserting hole 11 and gets in touch with the thermostat 3 through a temperature-sensor or sensing chip 301 at the base of coupler 10. The metal coupler 10 has prongs or segments that deflect outward in a radial or peripheral direction in the axis from the temperature-sensing chip 301 in the thermostat 3. There is a groove 1001 between the adjacent prongs of coupler 10, whose ends open outward like springs, which can prevent dry heating. When the heat transfer rod 9 is plugged into the heat transfer inserting hole 11 but not in touch with the temperature-sensing chip 301 of the thermostat 3, the metal coupler 10 can compress tightly the outside of the heat transfer rod 9 in advance to conduct heat to the chip 310 and thus test the temperature and improve safety. And it will be easy to plug the heat transfer rod 9 when the ends of metal coupler 10 open outward like springs.

Returning to the cooking appliance and plug seat connection structure, a supporting bracket 13 is installed on the peripheral edge of the described pan body 1. A limit cavity 15 is formed in the limit mask 14 extending out from the supporting bracket 13 above the plug 8, and a plug socket socket 6 is made up of the upper and lower terminal fixing covers 601, 602. An active rocker bar 16 is installed in the corresponding limit cavity 15 on the top of the upper terminal fixing cover 601, and it can be adjusted and fixed in the limit cavity 15 of the limit mask 14 when the socket 6 of the plug control box 2 is connected to the plug 8 of the pan body 1. When plugging the plug control box 2 with the pan body 1, the active rocker 16 can be used to firmly connect the plug through-hole 12 of the socket 6 in the plug control box 2 to the pan body 1, preventing loosening and being pulled out by children casually to improve safety. If the electric frying pan is not in use, the active rocker 16 can be adjusted to be separated from the limit cavity 15, plugging the plug control box 2 of the pan body 1 to make it easy to put them away. This locking mechanism is reasonable in overall structure, convenient and easy in operation.

By a screw 27, the rear-end of the described lower terminal fixing cover 602 is connected and fixed to the connecting sheet 26, which has a convex part 2601.The thermostat 3 is connected to the inner side of the convex part 2601 of the connecting sheet 26, and the temperature-sensing chip extends to the end of the heat transfer inserting hole 11 via the connecting sheet 26.

The described active rocker 16 is received into a correspondingly shaped recess with a blocking convex part 16a. Thus, one side of rocker can be blocked against rotation in the groove 601a of the upper terminal fixing cover 601. The other end of rocker 16 extends out from the plug control box 2 and has an external handle 17. When rotating the rocker, its central blocking convex part 16a will be blocked in the limit cavity 15 of the limit mask 14. In this way, the plug 6 of the pan body 1 can be locked in the socket 8 of the plug control box 2.

A protrusion 17a extends out from the inner side of the handle 17 of the described active rocker 16, and at the corresponding position of the convex buckle 17a on the side wall of the shell of the plug control box 2, there is a hole 2a in which the protrusion 17a is captured. When the blocking convex part 17a of the active rocker 16 is blocked in the limit block 15 of the pan body 1, the plug 8 can be locked in the socket 6 by fastening the protrusion 17a of the handle 17 to the hole 2a on the side wall of the plug control box 2.

There is a push button hole 2b on the side wall of the shell of the described plug control box 2, and a push button 18 is installed in the push button hole 2b; the push button 18 is connected to the rocker lever 19, which is cased by a return spring 20; an ejector block 21 is installed at the upper end of the rocker lever 19.

In order to unlock the plug 8 and the socket 6 conveniently, a pinion 19a extends from both sides near the central part of the described rocker lever 19; a supporting frame 2c is installed at the corresponding position of the supporting pinion 19a in the shell of the plug control box 2; the rocker lever 19 is installed on the supporting frame 2c via the supporting convex column 19a, the upper end (i.e. the ejector block 21) and lower end (i.e. push button hole 2b) of which are respectively connected to hole 2a and the push button 18; a return spring plate 19b is installed on the rocker lever 19 near the supporting pinion 19a, which is connected to the inner side of the shell of the plug control box 2 by a return spring 20; the rocker lever 19 can push the ejector block 21 out of the buckle hole 2a by compressing the return spring 20. When using, you just need to press the push button 18, the return spring 20 on the rocker lever 19 will be compressed to the inner wall of the plug control box 2. Then the ejector block 21 at the upper end of the rocker lever 19 will rotate about pinion 19a and extend out from the hole 2a and push away the convex buckle 17a on the handle 17, unlocking the protrusion 17a on the inner side of the handle 17 from the buckle position hole 2a.

The described plug control box 2 is made up of the upper and lower shell 201, 202 joining together.

Two mutually perpendicular engaging vertical and horizontal bevel gears 23, 24 are installed in the plug control box 2 below the described temperature control knob 5; the horizontal bevel gear 24 is connected to the thermostat 3; connecting shaft 23a is installed on the vertical gear 23, it extends out and then is plugged to the upper shell 201 of the plug control box 2; the temperature control knob 5 is plugged and connected to the connecting shaft 23a.

Protective cover 25 stretches from the lower end of the plug 8 of the described pan body 1, and can play a guiding and supportive role when plugging in the socket 6 of the plug control box 2.

Thus, a safe and convenient cooking appliance with a physically separable power and control module is described. The invention is thus not limited, but it susceptible to variation and modification without departing from the scope of the invention, which is defined by the following claims.

We claim:

1. A cooking appliance comprising:
a body unit having a cooking surface, the body unit including:
a heating unit thermally coupled to the cooking surface; and
a heat transfer rod having an end extending from the body unit;
a controller unit configured to be coupled to the body unit to provide electrical power to and to control the temperature of the heating unit, the controller unit including:
a thermostat thermally coupled to the heat transfer rod of the body unit;
a coupler between the thermostat and the heat transfer rod, the coupler releasably connecting the heat transfer rod to the thermostat;
a control knob connected to the thermostat; and
a locking member selectively actuable to secure the body unit and controller units together.

2. The cooking appliance of claim 1, the control knob connected to the thermostat by a pair of bevel gears abutting each other.

3. The cooking appliance of claim 1, the locking member including a safety button to prevent inadvertent release of the body unit from the controller unit.

4. The cooking appliance of claim 1, the locking member being biased into the locked position.

5. The cooking appliance of claim 1, the coupler being generally cylindrical and including a deflectable sidewall, wherein insertion of the heat transfer rod deflects the sidewall, which is urged into contact with the heat transfer rod.

6. The cooking appliance of claim 1, the coupler including a plurality of prongs arranged in a generally cylindrical manner, wherein the prongs are deflected by insertion of the heat transfer rod, but remain in close contact with the rod.

7. The cooking appliance of claim 5, wherein the coupler is carried by the thermostat and has a base with a temperature sensor.

8. A cooking appliance comprising:
a body unit having a cooking surface, the body unit including:
a heating unit thermally coupled to the cooking surface; and
a heat transfer rod having an end extending from the body unit;
a controller unit configured to be coupled to the body unit to provide electrical power to and to control the temperature of the heating unit, the controller unit including:
a flexible coupler configured to receive the heat transfer rod and establish thermal communication with a thermostat;
a control knob connected to the thermostat for adjusting the temperature of the heating element and cooking surface; and
a locking member selectively actuable to secure the body unit and controller units together.

9. The cooking appliance of claim 8, the control knob connected to the thermostat by a pair of bevel gears abutting each other.

10. The cooking appliance of claim 8, the locking member including a safety button to prevent inadvertent release of the body unit from the controller unit.

11. The cooking appliance of claim 8, the locking member being biased into the locked position.

12. The cooking appliance of claim 8, the coupler being generally cylindrical and including a deflectable sidewall, wherein insertion of the heat transfer rod deflects the sidewall, which is urged into contact with the heat transfer rod.

13. The cooking appliance of claim 8, the coupler including a plurality of prongs arranged in a generally cylindrical manner, wherein the prongs are deflected by insertion of the heat transfer rod, but remain in close contact with the rod.

15. The cooking appliance of claim 12, wherein the coupler is carried by the thermostat and has a base with a temperature sensor.

16. A cooking appliance comprising:
a body unit having a cooking surface, the body unit including:
a heating unit thermally coupled to the cooking surface; and
a heat transfer rod having an end extending from the body unit;
a controller unit configured to be coupled to the body unit to provide electrical power to and to control the temperature of the heating unit, the controller unit including:
a generally cylindrical metallic coupler having a deformable sidewall, the coupler configured to receive the heat transfer rod and establish thermal communication with a thermostat; and
a control knob connected to the thermostat for adjusting the temperature of the heating element and cooking surface;
a locking member selectively actuable to secure the body unit and controller units together; and
a safety button to prevent inadvertent actuation of the locking member.

17. The cooking appliance of claim 16, the control knob connected to the thermostat by a pair of bevel gears abutting each other.

18. The cooking appliance of claim 16, the coupler including a plurality of prongs arranged in a generally cylindrical manner, wherein the prongs are deflected by insertion of the heat transfer rod, but remain in close contact with the rod.

19. The cooking appliance of claim 16, wherein the coupler is carried by the thermostat and has a base with a temperature sensor.
